(19) United States
(12) Patent Application Publication
(10) Pub. No.: US 2002/0117692 A1
(43) Pub. Date: Aug. 29, 2002

(54) Moisture resistant LED vehicle light bulb assembly

(76) Inventor: Wen Chung Lin, Rancho Palos Verdes, CA (US)

Correspondence Address: CHAN LAW GROUP LC, 1055 W. 7TH ST,, SUITE 1880, LOS ANGELES, CA, 90017, US

(21) Appl. No.: 09/794,432

(22) Filed: Feb. 27, 2001

(51) Int. Cl. F21V 29/00

(52) U.S. Cl. 257/235; 362/267; 362/310; 362/800; 362/249

(57) ABSTRACT

The invention is a moisture resistant LED-illuminated vehicle bulb assembly capable of installation into a conventional vehicle incandescent bulb socket. The moisture resistant LED-illuminated vehicle bulb assembly satisfies a long felt need to provided a long life, bright and economic vehicle bulb that can be used as a replacement for incandescent bulb-type lamps or as original equipment in new vehicles. The moisture resistant LED-illuminated vehicle bulb assembly is employable in stop lamps, clearance/marker lamps, as well as combination brake, turn and tail lamps for passenger vehicle lamps and in heavy-duty trucks and trailers.

### BACKGROUND OF THE INVENTION

1. Field of the Invention

The present invention relates to a moisture resistant, light emitting diode (LED) illuminated vehicle bulb assembly that can be used as a replacement for incandescent bulb-type lamps or as original equipment in new vehicles. The LED-illuminated vehicle bulb assembly of the present invention offers moisture resistance with an extended life span over incandescent bulbs and also with minimized power requirements.

2. Description of the Related Art

A moisture resistant LED-illuminated vehicle bulb assembly is employable in stop lamps, clearance/marker lamps, as well as combination brake, turn and tail lamps for passenger vehicle lamps and in heavy-duty trucks and trailers. LED lamps ordinarily require the use of multiple LED's in order to satisfy the Federal Motor Vehicle Safety Standard (FMVSS) lighting requirements. Conventional LED's emit light in a relatively tight focus area requiring distribution of that light in order to illuminate seventy five (75) square centimeters of lens area and thus provide proper visibility.

Generally, LED's (light emitting diodes) offer a desirable reduction in maintenance costs when compared to incandescent bulbs, which burn out and require replacement. An LED may attain an operating life of up to 100,000 hours before beginning to degrade which is considerably longer than an incandescent bulb.

As discussed in U.S. Pat. 5,947,588, conventional vehicle light fixtures are typically comprised of a base attached to the bottom of the dome lens, a socket housing attached to the base plate discloses light-emitting diode (LED) light bulbs which can be used in conjunction with a conventional light fixture mounted to a vehicle. In the design disclosed in the '588 patent, the light fixture includes a hollow lens and a base plate attached to the lens. The base plate has a conventional socket housing with one or more contacts that are electrically coupled to a power source. The LED light bulb comprises an electrical circuit board and a plurality of light-emitting diodes mounted to the circuit board. The circuit board is electrically coupled and a connection post attached to the circuit board that is inserted in the socket housing of the light fixture. The light-emitting diodes are illuminated by the power source. In some of the conventional designs, no lens is provided that covers the LED's. The '588 patent states that the lens is attached to the base plate in the conventional manner.

There are problems associated with the conventional manner of attaching the lens to the base plate. In the design disclosed in the '588 patent, the wires connected to the power source are outside of the lens exposing the wires to the elements. The wires tend to short circuit when there is moisture, particularly when the insulation around the wire is degraded. In some instances, the conventional manner of attaching the lens to the base plate permits leaks. In addition, when the light fixture requires repair and replacement, prior designs required the wires to be disconnected from the power source necessitating soldering.

It is an objective to provide a number of LED light assemblies and the wire that make the electrical connection to power source to be mounted inside a moisture-resistant container. It is an objective of present invention to provide a LED vehicle bulb that may be readily inserted and replaced. The present invention can be used as a replacement for a conventional incandescent bulb type lamp or as original equipment in a new vehicle.

### SUMMARY OF THE INVENTION

The present invention is a moisture resistant LED-illuminated vehicle bulb assembly that does not required soldering for installation. The bulb of the present invention is capable of “plug-in” installation into a conventional vehicle incandescent bulb socket. It includes an electric circuit board having a top side and a bottom side. A plurality of light emitting diodes are mounted upon the top side of the electric circuit board.

The circuit board holding the LEDs is placed in a generally plastic base cup-shaped member. The plastic base cup has an upper surface, a lower surface, and an outer perimeter wall with a rim, outer surface, inner surface and a center cutout. The bottom side of the electric circuit board is attached to the upper surface of the plastic base cup.

A post suitable to electrically connect to a socket is affixed to the lower surface of the plastic base cup with the upper rim of the post attached to the outer surface of the plastic base cup.

A positive wire is provided. It includes a length of wire, a first end and a second end. The first end of the positive wire is attached to the electric circuit board. The length of wire is run through the cutout in the plastic base cup into the post. The second end of the positive wire is attached to the post.

A negative wire is provided. It includes a length of wire, a first end and a second end. The first end of the negative wire is attached to the electric circuit board. The length of wire is run through the cutout in the plastic base cup into the post. The second end of the negative wire is attached to the post.

A transparent plastic cover is provided. It includes an upper surface, a lower surface, and an outer perimeter wall. The outer perimeter wall has a rim, an outer surface and an inner surface. The rim of the transparent plastic cover is attached by a moisture resistant means to the rim of the plastic base cup.

A variation of the invention has the bottom side of the electric circuit board glued to the upper surface of the plastic base cup.

Another variation of the invention has the upper rim of the post attached by epoxy to the lower surface of the plastic base cup.

A different version of the invention has the post fabricated from conductive metal.

Further variation of the invention has the rim of the transparent plastic cover high-frequency welded to the rim of the plastic base cup, thus forming a moisture resistant container around the electric circuit board.

An additional variation of the invention has the transparent plastic cover possessing a shape and translucence sufficient to transmit and distribute the light from the plurality of light emitting diodes to attain a brightness and spatial distribution in compliance with the Federal Motor Vehicle Safety Standard (FMVSS) lighting requirements.

In yet another variation of the invention, the post includes two opposing protruding flanges and a base connector. The combination of the post and the two opposing flanges is capable of latching into slits provided in a socket and the base connector is able to electrically connect with the socket positive terminal. The base connector is electrically insulated from the post.

In yet still another variation of the invention, the combination of the post and the two opposing flanges is capable of latching into slits provided in a conventional vehicle incandescent bulb socket and the base connector is able to electrically connect with the socket positive terminal. The base connector is electrically insulated from the post.

In yet still a different variation of the invention, the plastic base cup is transparent.

### DESCRIPTION OF THE DRAWINGS

FIG. 1 is an exploded orthogonal view of the moisture resistant LEDilluminated vehicle bulb assembly.

### DESCRIPTION OF THE PREFERRED EMBODIMENT

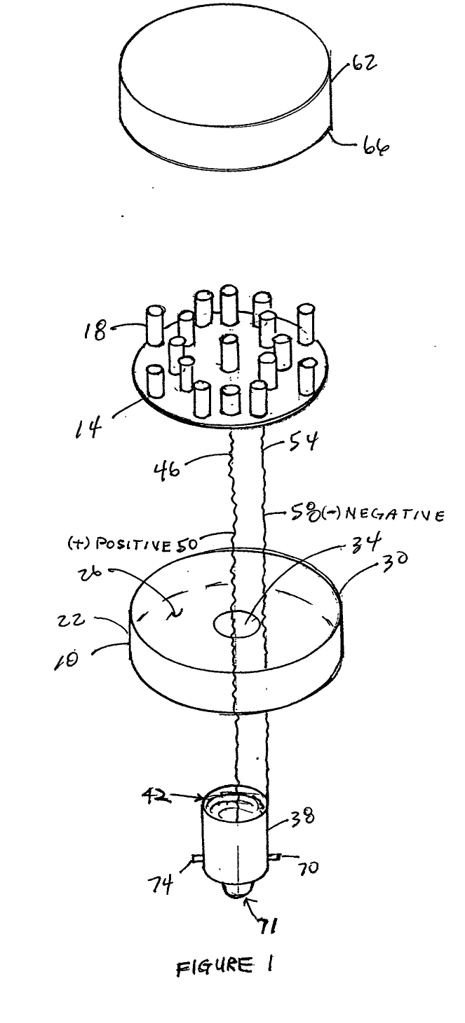

As shown in FIG. 1, the invention is a moisture-resistant LED-illuminated vehicle bulb assembly 10 capable of installation into a conventional vehicle incandescent bulb socket. It includes an electric circuit board 14 having a top side and a bottom side. A plurality of light emitting diodes 18 are mounted upon the top side of the electric circuit board 14.

The circuit board holding the LEDs is placed in a generally plastic base cup-shaped member 22. The plastic base cup 22 has an upper surface 26, a lower surface, and an outer perimeter wall with a rim 30, outer surface, inner surface and a center cutout 34. The bottom side of the electric circuit board 14 is attached to the upper surface 26 of the plastic base cup 22.

A post 38 suitable to electrically connect to a socket is affixed to the lower surface of the plastic base cup 22 with the upper rim 42 of the post 38 attached to the outer surface of the plastic base cup 22 over

A positive wire 46 is provided. It includes a length of wire 50, a first end and a second end. The first end of the positive wire 46 is attached to the electric circuit board 14. The length of wire 50 is run through the cutout 34 in the plastic base cup 22 into the post 38. The second end of the positive wire 46 is attached to the post 38.

A negative wire 54 is provided. It includes a length of wire 58, a first end and a second end. The first end of the negative wire 54 is attached to the electric circuit board 14. The length of wire 58 is run through the cutout 34 in the plastic base cup 22 into the post 38. The second end of the negative wire 54 is attached to the post 38.

A transparent plastic cover 62 is provided. It includes an upper surface, a lower surface, and an outer perimeter wall. The outer perimeter wall has a rim 66, an outer surface and an inner surface. The rim 66 of the transparent plastic cover 62 is attached by a moisture resistant means to the rim 30 of the plastic base cup 22.

A variation of the invention has the bottom side of the electric circuit board 14 glued to the upper surface 26 of the plastic base cup 22.

Another variation of the invention has the upper rim 42 of the post 38 attached by epoxy to the lower surface of the plastic base cup 22.

A different version of the invention has the post 38 fabricated from conductive metal.

Further variation of the invention has the rim 66 of the transparent plastic cover 62 high-frequency welded to the rim 30 of the plastic base cup 22, thus forming a moisture resistant container around the electric circuit board 14.

An additional variation of the invention has the transparent plastic cover 62 possessing a shape and translucence sufficient to transmit and distribute the light from the plurality of light emitting diodes 18 to attain a brightness and spatial distribution in compliance with the Federal Motor Vehicle Safety Standard (FMVSS) lighting requirements.

In yet another variation of the invention, the post 38 includes two opposing protruding flanges 70 and 74 and a base connector 71. The combination of the post 38 and the two opposing flanges 70 and 74 is capable of latching into slits provided in a socket and the base connector 71 is able to electrically connect with the socket positive terminal. The base connector 71 is electrically insulated from the post 38.

In yet still another variation of the invention, the combination of the post 38 and the two opposing flanges 70 and 74 is capable of latching into slits provided in a conventional vehicle incandescent bulb socket and the base connector 71 is able to electrically connect with the socket positive terminal. The base connector 71 is electrically insulated from the post 38.

In yet still a different variation of the invention, the plastic base cup 22 is transparent.

What is claimed is:

1. A moisture resistant LED-illuminated vehicle bulb assembly capable of installation into a conventional vehicle incandescent bulb socket, comprising:
an electric circuit board having a top side and a bottom side, a plurality of light emitting diodes mounted on said top side of said electric circuit board;
a plastic base cup having an inner surface, an outer surface, and an outer perimeter wall with a rim, an outer surface and an inner surface, and an opening, wherein said outer surface of said electric circuit board being attached to said upper surface of said plastic base cup;
a post suitable to electrically connected to a socket, said post having an upper rim, wherein said upper rim is affixed to said outer surface of the plastic base cup;
a positive and negative wire, each having a first end and a second end, said first end being electrically connected to said electric circuit board, said positive wire being run through said opening in said plastic base cup into said post, said second end of said positive wire being attached to said post, said negative wire being run through said opening in said plastic base cup into said post, said second end of said negative wire being attached to said post; and
a transparent cover having an upper surface, a lower surface, and an outer perimeter wall with a rim, an outer surface and an inner surface, said rim of said transparent plastic cover being attached by a moisture resistant means to said rim of said cover.

2. A moisture resistant LED-illuminated vehicle bulb assembly according to claim 1 wherein said bottom side of said electric circuit board being glued to said upper surface of said plastic base cup.

3. A moisture resistant LED-illuminated vehicle bulb assembly according to claim 1 wherein said upper rim of said post being attached by epoxy to said lower surface of said plastic base cup.

4. A moisture resistant LED-illuminated vehicle bulb assembly according to claim 1 wherein said post being fabricated from conductive metal.

5. A moisture resistant LED-illuminated vehicle bulb assembly according to claim 1 wherein said rim of said transparent plastic cover being high-frequency welded to said rim of said plastic base cup thus forming a moisture resistant container around said electric circuit board.

6. A moisture resistant LED-illuminated vehicle bulb assembly according to claim 1 wherein said transparent plastic cover possessing a shape and translucence sufficient to transmit and distribute the light produced by said plurality of light emitting diodes to attain a brightness and spatial distribution in compliance with the Federal Motor Vehicle Safety Standard (FMVSS) lighting requirements.

7. A moisture resistant LED-illuminated vehicle bulb assembly according to claim 1 wherein said post includes two opposing protruding flanges and a base connector, said post and said two opposing flanges combination being capable of latching into slits provided in a socket and said base connector being able to electrically connect with the socket positive terminal, said base connector being electrically insulated from said post.

8. A moisture resistant LED-illuminated vehicle bulb assembly according to claim 1 wherein said plastic base cup is transparent.

9. A moisture resistant LED-illuminated vehicle bulb assembly according to claim 7 wherein said post and said two opposing flanges combination being capable of latching into slits provided in a conventional vehicle incandescent bulb socket and said base connector being able to electrically connect with the socket positive terminal, said base connector being electrically insulated from said post.
